(19) United States
(12) Patent Application Publication
(10) Pub. No.: US 2021/0006692 A1
(43) Pub. Date: Jan. 7, 2021

(54) LENS MODULE AND IMAGING SYSTEM

(71) Applicant: AAC Optics Solutions Pte. Ltd., Singapore City (SG)

(72) Inventor: Junjie Yan, Shenzhen (CN)

(21) Appl. No.: 16/914,365

(22) Filed: Jun. 28, 2020

(30) Foreign Application Priority Data
Jul. 2, 2019 (CN) PCT/CN2019/094390

(51) Int. Cl. H04N 5/225; G03B 17/12; G02B 1/11

(52) U.S. Cl. CPC H04N 5/2254; G02B 1/11; G03B 17/12

(57) ABSTRACT

A lens module and an imaging system include a lens barrel and a plurality of lenses contained in the lens barrel. The plurality of lenses are sequentially arranged at intervals along an optical axis direction of the lens barrel, at least one of the plurality of lenses is a glass lens, and at least one layer of invisible light cutoff film on either of the object side surface and the image side surface of the glass lens. The imaging system may directly block the invisible light such as infrared light out of the imaging area through the glass lens without requiring an additional filter in front of the electronic image sensor. In this way, the length of the imaging system and the height of the lens module are reduced, and the number of optical surfaces between the lens module and the electronic image sensor is reduced.

### TECHNICAL FIELD

The present disclosure relates to the technical field of optical imaging, in particular to a lens module and an imaging system.

### BACKGROUND

The application of electronic image sensors in the field of photography has the problem that infrared light induction interferes with visible light imaging. In order to solve the above problem, the conventional lens module uses an infrared cutoff filter between the lens and the electronic image sensor to achieve interference-free imaging of visible light. Specifically, please refer to the structure of the example in FIG. 1, the reference numeral 10 denotes a lens, the reference numeral 20 denotes an infrared cutoff filter and the reference numeral 30 denotes an electronic image sensor. Generally, there are two ways for producing the infrared cutoff filter: one is to plate an infrared cutoff film and an ultraviolet cutoff film on the white glass plate, and the other is to plate an ultraviolet cutoff film on the integrated lens.

However, such conventional lens module with additional filters has two shortcomings. Firstly, the length of the imaging system and the height of the module are increased due to additional components between the lens and the electronic image sensor. Secondly, the types and intensity of ghosting are increased due to additional optical surfaces between the lens and the electronic image sensor, thereby affecting the subjective effect for taking pictures.

Therefore, it is necessary to provide a new type of lens module.

### SUMMARY

An objective of the present disclosure is to provide a lens module, which aims to solve the technical problems of incompact structure and multiple types and high intensity of ghosting for the existing imaging system.

To achieve the above objective, the technical solution of the present disclosure is as follows. A lens module is provided including a lens barrel and a plurality of lenses accommodated in the lens barrel. The plurality of lenses is sequentially arranged at intervals along an optical axis direction of the lens barrel.

At least one of the plurality of lenses is a glass lens, and at least one layer of invisible light cutoff film is provided on either of the object side surface and the image side surface of the glass lens.

As an improvement, the glass lens is a white glass lens, and at least one layer of infrared cutoff film and one layer of ultraviolet cutoff film are provided on either of the object side surface and the image side surface of the white glass lens.

As an improvement, the glass lens is a blue glass lens, and at least one layer of ultraviolet cutoff film is provided on either of the object side surface and the image side surface of the blue glass lens.

As an improvement, the invisible light cutoff film is arranged on the object side surface of the glass lens.

As an improvement, the glass lens is a first lens of the plurality of lenses from the object side to the image side.

As an improvement, an antireflection film is further provided on either of the object side surface and the image side surface of the glass lens.

The present disclosure has the beneficial effects as follows: in the lens module of the present disclosure, at least one of the plurality of lenses is a glass lens, and at least one layer of invisible light cutoff film is provided on either of the object side surface and the image side surface of the glass lens, such that the lens module may not require the infrared cutoff filter in the example (that is shown in FIG. 1), directly block the invisible light such as infrared light out of the imaging area of the lens module through the processed glass lens and prevent the invisible light from interfering with visible light imaging in the lens module. Accordingly, the lens module does not need to add additional filters in front of the electronic image sensor, thereby reducing the length of the imaging system and the height of the lens module, so that the overall structure will be more compact. Meanwhile, the number of optical surfaces between the lens module and the electronic image sensor is reduced, which reduces the types and intensity of ghosting, results in better subjective effect for taking pictures and better thermal stability of the lens module.

A further objective of the present disclosure is to provide an imaging system including the above-mentioned lens module.

The present disclosure has the beneficial effects as follows: the imaging system of the present disclosure with the above-mentioned lens module has a more compact lens structure and a better subjective effect for taking pictures.

### BRIEF DESCRIPTION OF THE DRAWINGS

FIG. 1 is a cross-sectional view of a lens module in the existing technology;

FIG. 2 is a cross-sectional structural view of a lens module in an embodiment of the present disclosure;

FIG. 3 is a partially enlarged view at A in FIG. 2.

### DETAILED DESCRIPTION

The present disclosure will be further described below with reference to the accompanying drawings and embodiments.

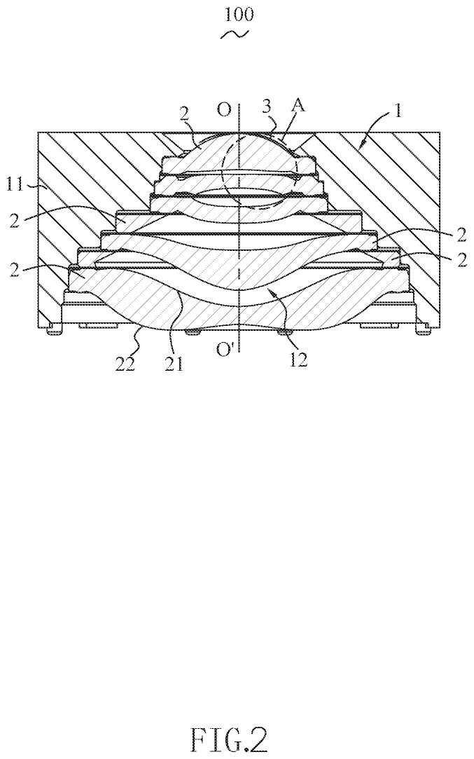

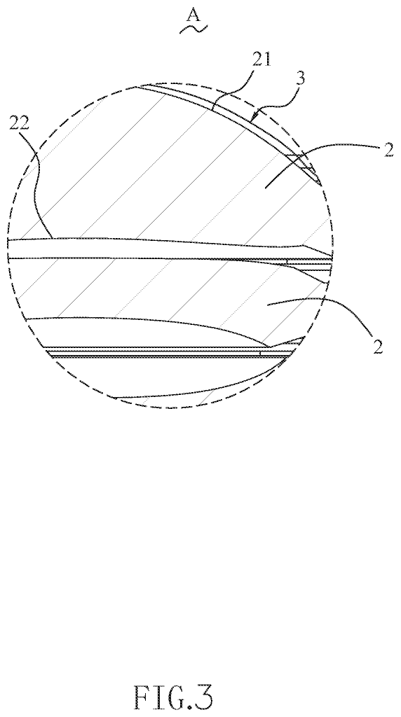

As shown in FIG. 2 and FIG. 3, the lens module 100 of the present disclosure includes a lens barrel 1 and a plurality of lenses 2. Generally, the lens barrel 1 includes a barrel wall 11 and an accommodating cavity 12 enclosed by the barrel wall 11. The plurality of lenses 2 are accommodated at intervals in the accommodating cavity 12 of the lens barrel 1 sequentially along the optical axis OO′ direction of the lens barrel 1. Each of the plurality of lenses 2 includes an image side surface 22 adjacent to the imaging surface side and an object side surface 21 that is arranged opposite to the image side surface 22 in the optical axis OO′ direction.

In this embodiment, at least one of the plurality of lenses 2 may be a glass lens 2. Among them, at least one layer of invisible light cutoff film 3 is provided on either of the object side surface 21 and the image side surface 22 of the glass lens 2.

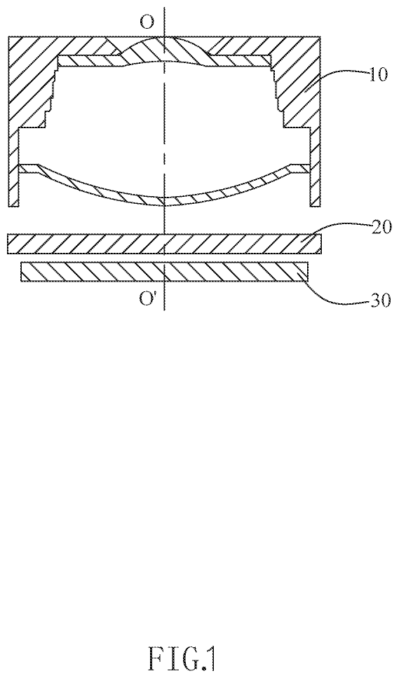

It can be appreciated that, by setting at least one of the plurality of lenses as the glass lens 2 and providing at least one layer of invisible light cutoff film 3 on either of the object side surface 21 and the image side surface 22 of the glass lens 2, the glass lens 2 may replace the original infrared cutoff filter in the example (that is shown in FIG. 1) to block invisible light such as infrared light to prevent the invisible light from interfering with visible light imaging. In this way, the lens module 100 does not need to add an additional filter in front of the electronic image sensor, thereby reducing the length of the imaging system and the height of the lens module, so that the overall structure of the lens module 100 is more compact.

Meanwhile, the number of optical surfaces between the lens module 100 and the electronic image sensor is reduced, which reduces the types and intensity of ghosting, results in better subjective effect for taking pictures and better thermal stability of the lens module 100, such that the user has a better subjective experience.

It should be noted that specifically in this embodiment, as shown in FIG. 2 and FIG. 3, the invisible light cutoff film 3 may be provided on the object side surface 21 of the glass lens 2.

In addition, specifically in this embodiment, as shown in FIG. 2, the glass lens 2 may be the first lens of the plurality of lenses from the object side to the image side, that is, the one closest to the object side of the lens module 100. Alternatively, the glass lens 2 may be selected from other lenses contained in the lens barrel 1.

Specifically, in one embodiment, the glass lens 2 may be a white glass lens. At least one layer of infrared cutoff film and one layer of ultraviolet cutoff film are provided on either of the object side surface 21 and the image side surface 22 of the white glass lens 2.

It can be appreciated that the above-mentioned invisible light cutoff film 3 may be an infrared cutoff film or an ultraviolet cutoff film. At least two layers of invisible light cutoff film are provided on the object side surface 21 or the image side surface 22 of the white glass lens. In this way, the glass lens 2 may simultaneously block invisible light such as infrared light and ultraviolet light out of the imaging area of the lens module 100. Alternatively, more layers of invisible light cutoff film may be provided on the object side surface 21 or the image side surface 22 of the white glass lens 2, and the number of layers of invisible light cutoff film, the types of invisible light that may be blocked and the like may be determined according to actual needs.

In a further embodiment, in order to block some invisible light out of the imaging area of the lens module 100, the glass lens 2 may be a blue glass lens. The blue glass lens 2 itself has an infrared cutoff function, and at least one layer of ultraviolet cutoff film is provided on either of the object side surface 21 and the image side surface 22 of the blue glass lens 2. It can be appreciated that the above-mentioned invisible light cutoff film 3 may be the ultraviolet cutoff film.

It should be noted that, without increasing the types and intensity of ghosting, in order to ensure a sufficiently compact structure of the lens module 100, preferably, one layer of the above-mentioned ultraviolet cutoff film 3 is provided. Alternatively, multiple layers of ultraviolet cut-off film 3 or other types of invisible light cutoff film may also be directly provided, and the number of the layers of the ultraviolet cutoff film 3 may be determined according to actual needs.

It should also be noted that the above-mentioned ultraviolet cutoff film 3 may be provided on the glass lens 2 through a plating process. Alternatively, other suitable processing methods, such as spraying, adhesion, etc., may also be used.

In one embodiment, an antireflection film (not shown) may be provided on either of the object side surface 21 and the image side surface 22 of the glass lens 2.

The present disclosure also provides an imaging system (not shown) including the lens module 100 described above. It should be noted that the imaging system may be applied to mobile phones, tablet computers, cameras, ATMs and other products.

It can be appreciated that the imaging system with the above-mentioned lens module 100 has a more compact lens structure and a better subjective effect for taking pictures.

The above-described are merely the embodiments of the present disclosure. It should be noted that those skilled in the art may make improvements without departing from the inventive concept of the present disclosure, such improvements, however, fall within the protection scope of the present disclosure.

What is claimed is:

1. A lens module, comprising a lens barrel and a plurality of lenses accommodated in the lens barrel, the plurality of lenses being sequentially arranged at intervals along an optical axis direction of the lens barrel, wherein:
at least one of the plurality of lenses is a glass lens, and at least one layer of invisible light cutoff film is provided on either of the object side surface and the image side surface of the glass lens.

2. The lens module according to claim 1, wherein the glass lens is a white glass lens, and at least one layer of infrared cutoff film and one layer of ultraviolet cutoff film are provided on either of the object side surface and the image side surface of the white glass lens.

3. The lens module according to claim 1, wherein the glass lens is a blue glass lens, and at least one layer of ultraviolet cutoff film is provided on either of the object side surface and the image side surface of the blue glass lens.

4. The lens module according to claim 1, wherein the invisible light cutoff film is provided on the object side surface of the glass lens.

5. The lens module according to claim 1, wherein the glass lens is a first lens of the plurality of lenses from the object side to the image side.

6. The lens module according to claim 1, wherein an antireflection film is further provided on either of the object side surface and the image side surface of the glass lens.

7. The lens module according to claim 2 wherein the invisible light cutoff film is provided on the object side surface of the glass lens.

8. The lens module according to claim 2, wherein the glass lens is a first lens of the plurality of lenses from the object side to the image side.

9. The lens module according to claim 2, wherein an antireflection film is further provided on either of the object side surface and the image side surface of the glass lens.

10. The lens module according to claim 3 wherein the invisible light cutoff film is provided on the object side surface of the glass lens.

11. The lens module according to claim 3, wherein the glass lens is a first lens of the plurality of lenses from the object side to the image side.

12. The lens module according to claim 3, wherein an antireflection film is further provided on either of the object side surface and the image side surface of the glass lens.

13. An imaging system, comprising a lens module according to claim 1.
